(19) United States
(12) Patent Application Publication
(10) Pub. No.: US 2012/0198399 A1
(43) Pub. Date: Aug. 2, 2012

(54) SYSTEM, METHOD AND COMPUTER PROGRAM FOR DETERMINING FIXED VALUE, FIXED TIME, AND STIMULUS HARDWARE DIAGNOSIS

(76) Inventors: Sean Arash Safarpour, Toronto (CA); Duncan Philip Norman Smith, Toronto (CA); Yu-Shen Yang, North York (CA); Andreas Veneris, Toronto (CA)

(21) Appl. No.: 13/017,864

(22) Filed: Jan. 31, 2011

(51) Int. Cl. G06F 17/50

(52) U.S. Cl. 716/106

(57) ABSTRACT

The present invention provides a system, method and computer program for determining constraint errors in hardware design debugging. The invention may be included as part of a complete verification solution. The method involves applying a diagnostic technique such that under-constrained problems are identified by adding a model-free error suspect or error candidate on the primary input signals (or other signals where constraints or stimuli are usually added). The present invention also provides a system, method and computer program that enables hardware design correction, consisting of the use of generating correction waveforms for identifying one or more corrections at the gate level and/or logic level of the hardware design. A number of different diagnostic techniques can be used in this way for example, include simulation-based techniques, BDD-based techniques, SAT-based techniques and path tracing. The method described can be implemented as part of a debugging computer system or computer program, including an automated debugger. The method described herein can also be implemented into a design correction engine that is operable to generate correction waveforms for each of the under constrained signals to provide to a user or automated system or computer program deeper insight for under-constrained problems. Furthermore, under-constrained signals may be combined with one or more correction waveforms to provide a software fix or external fix to a fabricated chip by providing a value sequence that is operable to avoid an error or bug in the fabricated chip.

### FIELD OF THE INVENTION

The present invention relates to the field of hardware design debugging. The present invention more particularly relates to determining constraint errors in hardware design debugging. The present invention also relates to enabling hardware correction by providing correction values to enable the correction of potential error sources of a hardware design.

### BACKGROUND OF THE INVENTION

Hardware design debugging is the process of finding or locating errors in designs after verification methodologies and techniques determine the presence of such errors. Design debugging is considered a major bottleneck in the overall hardware design cycle that consumes between 30-35% of the design effort. Today, design debugging is performed almost exclusively manually by hardware designers and verification engineers using graphical navigation tools such as Springsoft Verdi, Springsoft Debussy, Synopsys DVE, Cadence SimVision or Mentor Graphics Questa. This is a tedious, time consuming and costly manual process.

Hardware design debugging typically involves: (1) verification, (2) debugging, and (3) correction. Verification, in turn, typically involves: (1) determining whether errors exist in the design, using test benches and simulation or formal verification tools; (2) if errors exist, determining the root cause of the errors (locating the source), which is performed either manually by engineers with the use of waveform and source code viewers or automatically with automated design debug/diagnose technology such as Vennsa OnPoint™; (3) when the location of the error source or the root cause has been identified, modifying the source code or design such that the error or bug is removed, which is performed manually by engineers by manipulating the source code.

A typical hardware design cycle starts with a specification document that describes the functionality, timing and general constraints of the design. The specification is used to both create the design, typically implemented in Hardware Description Language (HDL), and to determine the expected behaviour specified by the verification environment. HDL designs are most commonly implemented at the Register Transfer Level (RTL) using Verilog™ or VHDL. This approach to hardware design typically uses hierarchical and modular design concepts, where blocks or sub-designs are instantiated inside one another and connected together. Hierarchical and modular development is favoured as it is ideal for design reuse, development in a large group, and for verification and debugging among others.

Verification typically means determining whether errors exist in the design, which may be performed using test benches and simulation tools or formal verification tools. A typical verification environment is composed of a web of advanced tools, methodologies and techniques. Each verification component has a set of strengths and weaknesses which make it ideal of specific verification tasks. Popular verification approaches include the use of one or more of the following:
1. Simulation engines driven by test benches (hand written or automatically generated). Known as the work horse of verification, simulation engines are used extensively to quickly test a wide range of input stimuli and find errors quickly. In practice, simulation engines can rarely be used to prove the correctness of a design. A test bench is used to drive the simulation engine. The test bench can be written in a multitude of language (and combinations of thereof) such as Verilog, System Verilog, C, C++, VERA, e, MATLAB amoung others. Generally speaking the test bench is composed of two types components: stimulus generation and correctness checking. Stimulus generation components create a sequence of data input values to exercise the design (often attempting to replicate different operating conditions of the design/chip). Correctness checkers attempt to catch misbehaviour of the design/chip. Some correctness checkers are assertions, protocol monitors, and scoar boards. Some test bench components are also known as verification intellectual property (VIP) and can be purchased from 3^{rd} party vendors.
2. Formal verification tools. These are used to formally verify specific properties, corner cases, or equivalences with other designs or models. Due to their slow performance compared to simulation engines, they are employed to prove conformity of important properties. Some formal verification tools use a combination of simulation and formal techniques to verify properties, corner cases and increase verification coverage. They balance the strengths and weaknesses of both approaches.

Each of the above approaches compares the design against a model derived from the specifications to determine whether the design demonstrates a correct or erroneous behaviour.

If the verification methodologies and techniques determine that an error exists in the design (i.e. verification fails), then the design is debugged to find the exact error source.

Debugging involves a determination, if errors exist, of the root cause of the errors (locating the source) either manually by engineers with the use of one or more simulation waveform and source code viewers or automatically with automated design debug/diagnose technology. Debugging can be a manual task where the verification engineer typically uses the erroneous response of the design, the expected behaviour as stated by the specifications, and the input stimuli to determine what modules, gates, HDL statements or signals are responsible for the erroneous behaviour. The manual debugging process typically starts by examining the erroneous primary outputs and tracing all suspect gates, signals, and modules backwards through the design. Graphical navigation tools can be used to ease the manual tracing process. Suspect components are those whose values appear to be inconsistent with those of the specifications. Needless to say, debugging is usually an ad hoc process where the verification engineers' knowledge of the design and debugging experience play a major role in the efficiency of the process.

FIG. 1 illustrates a typical verification environment based on dynamic simulation and test bench. Input values for the design under verification are generated by a stimulus generator and the output of the design is verified using a correctness checking mechanism such as a Verilog checker, PLI/VPI checker, a golden model and/or an assertion. FIG. 2 illustrates a typical verification environment using formal property checkers where the design and a set of input and state constraints and correctness checking mechanism are provided to the formal verification tool.

FIG. 3 illustrates a design and potential suspect error sources, which are indicated by stars. The design and potential suspect error sources are provided to a debugger to determine whether the suspects are actual error locations. Once a suspect error source is found, the verification engineer attempts to correct the error and reruns the verification step to ensure that the problem has been rectified. In practice, finding the actual error source and correcting the problem is done in a trial-and-error manner, where many iterations may be needed until the error is removed.

When verification results in the finding of a suspect error source, it may be due to three possible problems, or a combination of any of them: (1) an error in the design; (2) an error in the checking mechanisms of the design (i.e. the correctness checker component of the test bench); and (3) an error in the stimulus or constraints of the design (i.e. the stimulus generator component of the test bench). There have been many proposals for performing verification for an error in the design or in the checking mechanisms of the design.

One particular debugging approach was disclosed in U.S. Pat. No. 6,366,874 to Lee et al., which teaches a system and method for browsing graphically an electronic design based on a hardware description language specification. According to the technique, a user interacts with the system to browse or navigate through the design to find the error locations manually. However, the approach is not automated, requiring the constant input of a user. As well, the solution is tied to a particular graphical representation of the problem.

Other diagnosis methods have been proposed. For example, path tracing is a diagnosis technique that can be used find an error source in a gatelevel representation of a design given a set of input/output vectors that demonstrate the erroneous behaviour [1]. This technique traverses the gatelevel circuit backwards starting at the primary inputs and identifies a set of gates that may be responsible for the erroneous behaviour.

Symbolic simulation (or BDDs) can be used as a means to diagnose erroneous gatelevel designs [2]. The circuit and vectors are used to build a BDD which can be solved to find the gates responsible for the erroneous behavior.

Furthermore, SAT-based debugging solves the diagnosis problem by building a constrained satisfiability problem and uses a SAT solver to find solutions to the problem [3]. The inputs to the problem are a gatelevel circuit and a set of vectors used to detect the error. The output is a set of gates that may be responsible for the erroneous behaviour. The industrial tool OnPoint™ by Vennsa Technologies is an automated debugger that uses formal and simulation technologies. The output of OnPoint™ are suspects in the RTL source code that can be changed to fix the failures. Automatic debugging approaches have been disclosed in U.S. patent application Ser. No. 11/556,466 to Veneris et al. and U.S. patent application Ser. No. 11/938,012 to Veneris et al., both of which are incorporated herein by reference. Veneris et al. teaches a plurality of diagnosis methods for enabling hardware debugging. The results of the debugging stage can be used by an engineer to manually correct a design.

However, solutions for determining whether there is an error in the stimulus or constraints of the design are not well known.

Also, once a suspect error source is found, the verification engineer attempts to correct the error and reruns the verification step to ensure that the problem has been rectified. In practice, finding the actual error source and correcting the problem is done in a trial-and-error manner where numerous iterations may be needed until the error is removed.

What is required is means by which to determine whether there is an error in the stimulus or constraints of the design. What is also required is a solution for correcting a design as a final stage of hardware design debugging that is more efficient that the current trial-and-error methods.

### BRIEF DESCRIPTION OF THE DRAWINGS

A detailed description of the preferred embodiments is provided herein below by way of example only and with reference to the following drawings, in which:

FIG. 1 illustrates a typical verification environment based on dynamic simulation and test bench.

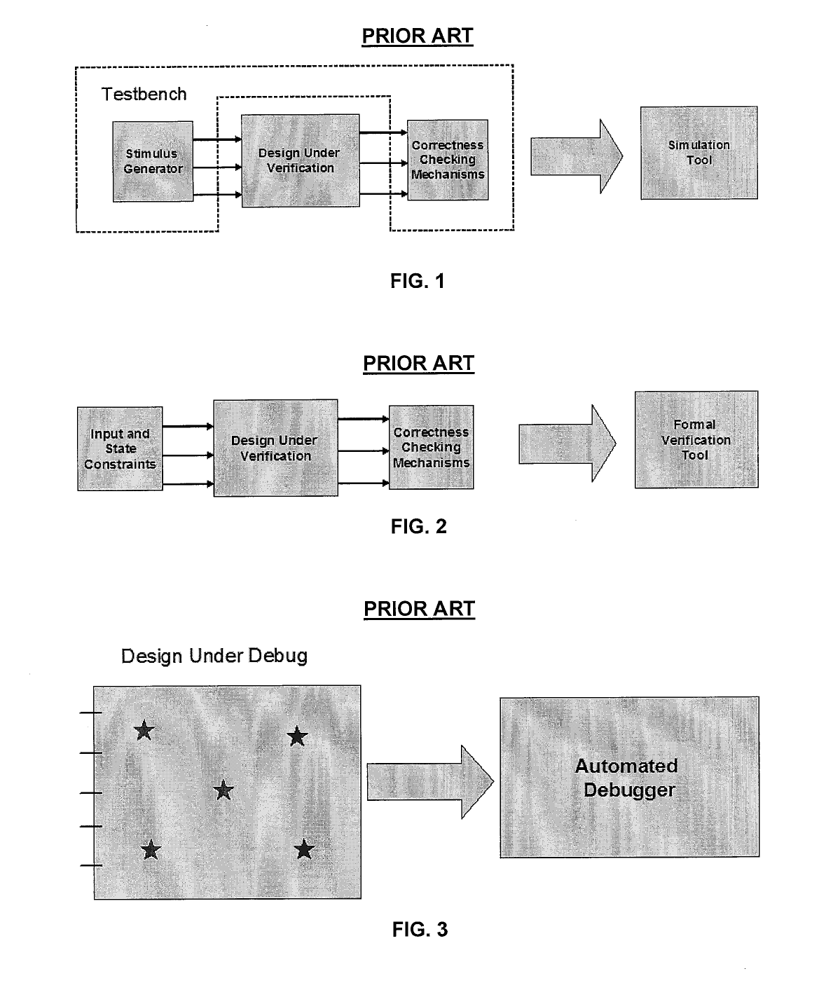

FIG. 2 illustrates a typical verification environment using formal property checkers where the design and a set of input and state constraints and correctness checking mechanism are provided to the formal verification tool.

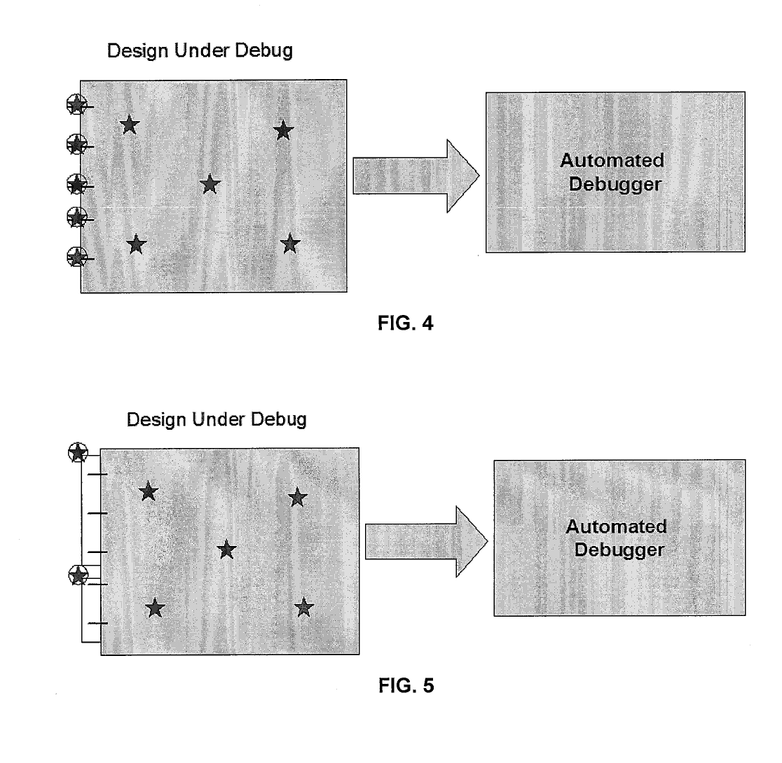

FIG. 3 illustrates a design and potential suspect error sources.

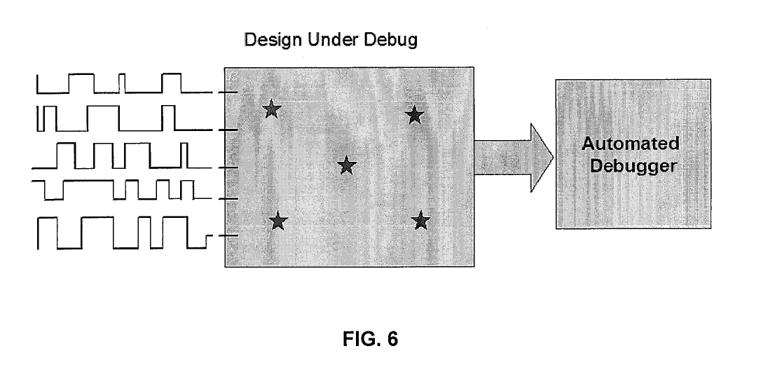

FIG. 4 illustrates suspected error sources being constraints of the design.

FIG. 5 illustrates suspected related error sources being diagnosed as a group.

FIG. 6 illustrates the application of a model-free error suspect or error candidate on a primary input signal of an under-constrained design.

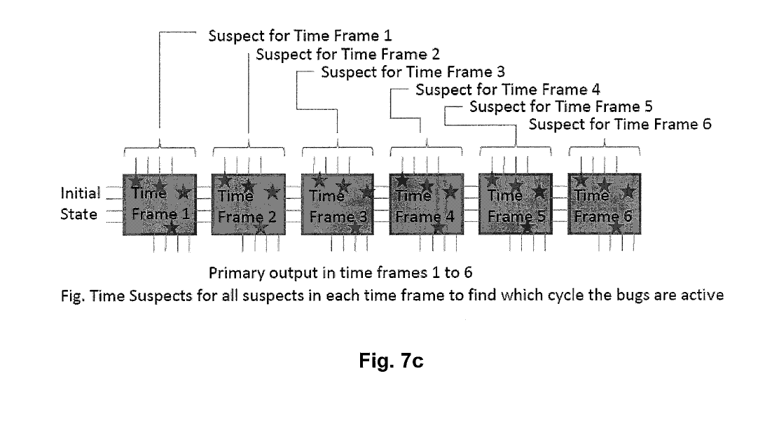

FIGS. 7a, 7b, 7c, 7d, and 7e illustrate the application of a time frame expansion based diagnosis method to identify under-constrained problems.

FIG. 8 illustrates a system in accordance with the present invention as implemented in a verification process.

FIG. 9 illustrates an example of a correction waveform for correcting or fixing an error source of a hardware design.

FIG. 10 illustrates an example hardware design with which the present invention is operable.

FIG. 11 illustrates an example of a correction waveform including explicit “don't cares”.

In the drawings, one embodiment of the invention is illustrated by way of example. It is to be expressly understood that the description and drawings are only for the purpose of illustration

### SUMMARY OF THE INVENTION

The present invention provides a system, method and computer program for determining stimulus errors in hardware design debugging. The invention may be included as part of a complete verification solution.

Hardware design errors may be caused by: (1) the wrong constraint being driven into the design during functional simulation or emulation by the test bench as opposed to a bug or error in the design; (2) wrong constraints being provided by a user or tool to a formal verification tool (such as a property checker such as Cadence Incisive Formal Verifier, Synopsys Magellan, Mentor Graphics 0-in, or Jasper Automation's JasperGold, etc.); and (3) wrong stimulus driving the physical chip by an external module or chip or software-driven values by another chip. The present invention addresses bugs or errors caused by incorrect application of constraints and stimulus into the design or chip.

The method involves applying a diagnostic technique onto sets of inputs of the design under verification (or design under test). As with most diagnostic techniques, the design, simulation trace (or counter-example) and one model for a correct or expected behaviour is required. One diagnostic technique can opt to add a model-free error suspect or error candidate on the primary input signals (or other signals where constraints or stimuli are usually added) and thus generate an under constrained problem. The user or the automated system can apply such diagnosis points to a combination of inputs, individual inputs or groups of inputs (or combinations thereof) or in an iterative and hierarchical manner. The diagnosis technique will identify the input set that can fix the problem by changing the stimulus or constraints to the verification problem. A number of different diagnostic techniques can be used in this way for example, include simulation-based techniques, BDD-based techniques, SAT-based techniques and path tracing. One such tool is Vennsa Technologies' OnPoint that can diagnose different RTL and design components in a hierarchical manner.

The method described can be implemented as part of a debugging computer system or computer program, including an automated debugger. The method described herein can also be implemented into a design correction engine that is operable to generate correction waveforms for each of the under constrained signals (and incorrect input or stimulus) to provide to a user or automated system or computer program deeper insight for under-constrained problems. Furthermore, under-constrained signals may be combined with one or more correction waveforms to provide a stimulus fix through a test bench, or software fix through processor instructions or external fix through change of output-input communication of a fabricated chip by providing a value sequence that is operable to avoid an error or bug in the fabricated chip.

In a second related aspect of the present invention, a system, method and computer program that enables hardware design correction is also provided that consists of using the generation of correction waveforms for identifying one or more corrections at the gate level and/or logic level of the hardware design. This aspect of the invention may be used in combination with the stimulus based diagnosis described in order to enable improved hardware correction. The waveform based hardware design correction may be implemented using a hardware correction engine. The inputs to the hardware correction engine may include a design input, one or more diagnose vectors comprising an input sequence and at least one set of expected output sequence, and optionally locations in the design to provide correction waveforms. The hardware correction engine is operable to process these inputs using a range of different techniques including simulation-based techniques, BDD-based techniques, SAT-based techniques and replacement or logic correction. The hardware correction engine may provide to a user of the system and computer program of the present invention, based on the analysis of the inputs, a selection of suggested techniques for processing the inputs. For each set of input signals provided and for each diagnose vector, a correction waveform is generated spanning the length (time) of each diagnose vector, and displayed for a user to review. The correction waveform enables a user of the system and computer program to review the correction waveform to identify the one or more corrections at the gate level and/or logic level of the hardware design. Furthermore, diagnostic techniques can identify times for each diagnostic vector when the fix waveform values are required. This gives engineers information about when the bug is active and when the fix is needed.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### DETAILED DESCRIPTION OF THE INVENTION

The present invention, in one aspect thereof, provides a system, method and computer program for determining bad stimulus to inputs or constraint errors (under constrained, over constrained, or incomplete constraints) during verification by means of automated hardware design debugging. The invention may be included as part of a complete verification solution.

When verification of an integrated circuit design fails, it may be due to three problems (or a combination of these):
3. A bug/error in the design implementation (in RTL, gate level, transistor level, or higher level implementation);
4. A bug/error in the checking mechanisms of the test bench (the environment that validates the correctness of the design);
5. A bug/error in the stimulus or constraints of the test bench (the environment that creates the stimulus that drives the design).

Automatically locating the bug in the design (problem 1) and the checking mechanisms (problem 2) are addressed by the prior art, and in particular the co-pending Veneris et al. patent applications. Automatically finding any problems with the stimulus or constraints of the verification process is addressed by this invention. Currently finding these problems is a manual task where engineers must use tools such as Springsoft Verdi and Debussy, Synopsys DVE, or Cadence SimVision, or Mentor Graphic Questa to traverse between different aspects of the design and test bench in order to identify problems. Other engineers only use source code viewers such as emacs and vi to explore the test bench environments.

The problem with the stimulus or constraints of a designs can encountered in three different verification flows: (1) test bench and dynamic simulation or emulation flow (called “simulation flow”); and (2) formal verification flow, which includes equivalence checking and property checking tools; and (3) bad stimulus during the physical validation of the chip or prototype.

In the simulation, flow errors are caused by the test bench stimuli, which drive the hardware design. The test bench stimuli are incorrect for the function or behaviour that is being verified versus what is expected. Typically the set of inputs of a chip must conform to a set of expectations called protocol. The design is implemented assuming that the protocol is respected and that the input stimulus will conform to the assumptions made. For example, a certain protocol can require that two input signals “A” and “B” be mutually exclusive. When signal “A” is high, the chip is expected to perform function “A”, when signal “B” is high, the chip is expected to perform function “B”. The designer can chose to implement his design assuming that “A” and “B” will never be high at the same time, however, if the test bench or block that is driving “A” and “B” does not respect that fact, the circuit can behave unexpectedly. In this case, a functional correctness checker can “fire” thinking that a bug has occurred, but upon closer debugging the problem one will eventually see that the “bug” is actually with the test bench where “A” and “B” where both high at the same time. This is a simple example for a protocol, but much more complicated sets of protocols, assumptions, or specifications on the input/output set of a design are typical. In this case, a stimulus diagnosis engine such as the one proposed here, will be able to identify the inputs for signal “A”, “B”, or both in order to fix the checker from firing. When input signals suspects are combined with a correction waveform this can provide stimulus fix, a software fix or external fix (such as using an external chip) where the signal, the value and the exact values required prevent the failure or error from occurring is provided to the user.

Similarly, formal verification tools such as a property checker such as Cadence Incisive Formal Verifier, Synopsys Magellan, Mentor Graphics 0-in, or Jasper Automation's JasperGold, etc.) and equivalence checkers such as Cadence LEC, Synopsys Conformal, Mentor Graphics FormalPro, and Calypto SLEC will mathematically prove or disprove the correctness of a design. Typically a correctness model such as an assertion must be provided to the tools. Assertion languages can include System Verilog Assertions (SVA), Property Specification Language (PSL), or Open Verification Languages (OVL). Before a particular behaviour can be verified (either using equivalence checking or property checking, for example) the inputs of the design must be constrained by the user (or sometimes generated by another tool or script) to allow the verification tool to “set up” or initialize the design correctly, and obey the established design protocol. These constraints are often provided to the tool as “assumption” properties or constraints. Languages span from SVA, PSL or proprietary 3rd party language. With the given constraints, the formal verification tools will generate a single or set of stimulus vectors (either in a test bench implemented in Verilog or other RTL language or in a database format such as VCD or FSDB) that can result in the failure of one or more correctness checkers when simulated. Considering the above example, if the design is not properly constrained by exclusive telling the tool that signal “A” and “B” must be high at mutually exclusive times, then a failure of the design can be achieved. As in the case in the simulation example, the engineer will not know that the failure was caused by missing constraints that in turn resulted in a test bench that violated the design input protocol until it is manually debugged. Again, the proposed technique is capable of identifying the input(s) that should be constrained to result in behaviour that would conform to the protocol.

It should be noted that constraints are often applied to primary inputs of the design, however they can also be applied to other signals and memories within of the design. It is within the scope of the present invention to include application of constraints to inputs and other signals and memories of a design. For example, the initialization values of a memory can also result in failures if assumptions about these values are not respected by the formal verification tool through constraints.

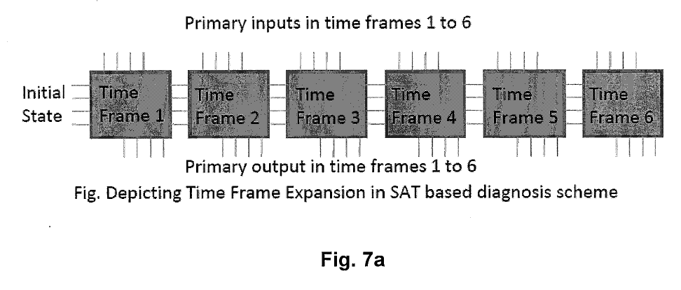

In some cases, the failure is caused because the formal verification problem is under-constrained. This means that the formal verification tool can assign any values it desires in order to result in a failure. The result is a test bench that violates the design input, bus, or interface protocol (assumptions, expectations). As such the simulation of the design will result in the failure of the expected behaviour of the design. FIG. 4 illustrates the application of a model-free error suspect or error candidate on a primary input signal of an under-constrained design. Existing diagnostic techniques can be modified to identify under-constrained problems by adding a model-free error suspect or error candidate on the primary input signals (or other signals where constraints or stimuli are usually added such as memory). The diagnostic technique can diagnose the inputs/signals individually or in groups, in a single pass or in multiple passes, in a hierarchical and iterative manner or in a flat manner. These existing diagnostic techniques may, for example, include simulation-based techniques, BDD-based techniques, SAT-based techniques and path tracing. Certain techniques may work better for certain problems than for others.

For SAT-based techniques, for example, this means adding a multiplexer-like (or clause-based) correction model to all the primary inputs. Or, in another example, for a BDD-based technique, a BDD must be constructed for each primary input. For simulation-based models values must be added to the primary inputs and simulated (either randomly or through heuristics). In all these cases, the inputs must be constrained for all time frames where their values can sequentially propagate to the points where the failure is occurring and the new values must result in the passing of the correction model. Note that in most diagnostic techniques the same input in multiple frames is considered the same even though the values required in different time-frames may be different. This means that the solution is irrespective of the time-frames the bas stimulus or constraints are active.

The suspects may first be added to the inputs individually or in groups and solved by iterations. One example is to group sets of inputs using heuristics such as related inputs, connected through fan-outs, by naming consistency, or by user input. FIG. 4 illustrates suspected error sources in the design (both inside and on the inputs), in this case, each input is considered individually. If the problem or error is with constraints/stimulus of the design then the diagnostic tool will find some of these inputs suspects as solutions as shown with the stars in circles.

A primary challenge is that a correction model applies only to individual signal bits or single inputs. Since constraints are typically applied to a set of signals or a “bus” of signals, these under-constrained problems must identified as well, which is a technical challenge also known as the multiple cardinality diagnosis problem. Unfortunately the computer complexity of multiple cardinality problems grows exponentially with respect to the cardinality. To avoid this problem, the under-constrained problem can be solved hierarchically in multiple iterations. Note that even for single bits, the solutions must be found for all time-frames, therefore the input suspects must be placed on all inputs (or other signals of interest) for all the clock cycles (or time-frames). Also note that there can be multiple solutions that the diagnostic tool can identify, therefore, the tool must be asked to find all such solutions. In a SAT-based diagnostic tool this is accomplished by generating a “blocking clause” that prevents the SAT solver to find the same solution again and the problem can be solved yet again.

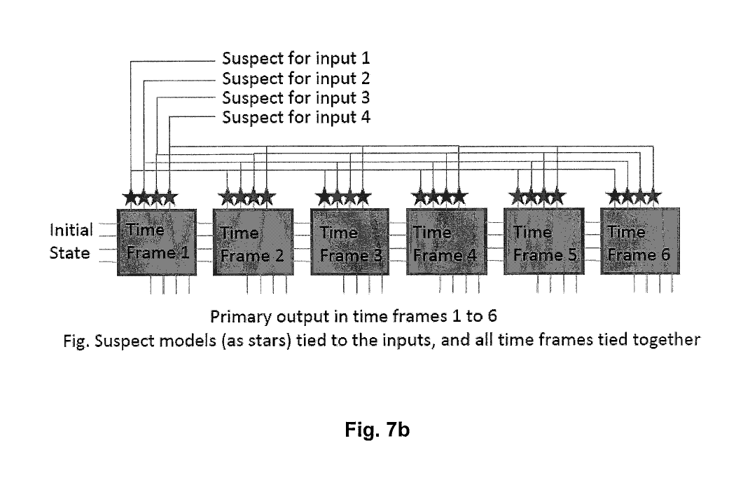

FIG. 5 illustrates suspected related error sources being diagnosed as a group. Often constraints on inputs or other signals are related and must be diagnosed as a group. Multiple inputs can be grouped together and represented by a single variable. In FIG. 5, for example, each rectangle surrounding multiple inputs represents a group while the star in the circuit represents the suspects that the diagnostic will must decide on. The automated debugger can find a group of signals that have constrain/stimulus errors if any one of these may be under-constrained or have a have an incorrect value. The grouping of inputs can be done iteratively on many different levels. At one extreme all inputs can be grouped into 1 group and at the other extreme each can be individually group. If required, combination of groups and single signals can also be diagnosed.

For example, one iterative and hierarchical algorithm for SAT-based problems includes: (1) group related primary inputs in a group (grouping can be done based on heuristics such as by buses, or functional association, or module association, or combinations, etc.); (2) for each group add a correction model, for example by adding a multiplexer-like model on every input, except that the select lines may be tied together; (3) generate the SAT-based problem and solve it with N=1 . . . N_max where N_max is the maximum number of groups or provided by the user; (4) the groups found as solutions are saved and provided to the user. For the individual signals within the group, iterations can be run from step 1 using, potentially, more detailed groupings. The solutions found in step 4 may be the under-constrained groups/buses and individual signals. These signals can be constrained in order for the failure to pass.

The present invention can also be used in conjunction with correction waveforms for each of the under constrained signals to provide to a user or automated tool in depth insight for under-constrained problems. More specifically, for each group of inputs/signals that is diagnosed, the “time diagnosis” process can be performed in a separate iteration to identify the time and the value required for the correction of fix of the stimulus of the problem.

A further improvement is to limit the number of value combinations of the primary input correction waveforms. Since constraints on under-constrained primary inputs do not change significantly, the correction models can be modified to: (1) allow only constant values; (2) allow single changed values; (3) allow only changes X and constants only; and/or (4) many others. There are many ways to implement these constraints. For example, in SAT-based debugging it can be done by the following: (1) for each multiplexer correction model, connect the value signal (the new input to the multiplexer); (2) for each multiplexer correction model, add an XOR gate that compares the value of the previous time frame with the current one and add logic to ensure that only one of the XOR outputs is 1; and/or (3) for each multiplexer correction model, add an XOR gate that compares the value of the previous time frame with the current one and add logic to ensure that only one of the XOR outputs is 1, as long as one of the XOR inputs is not an X.

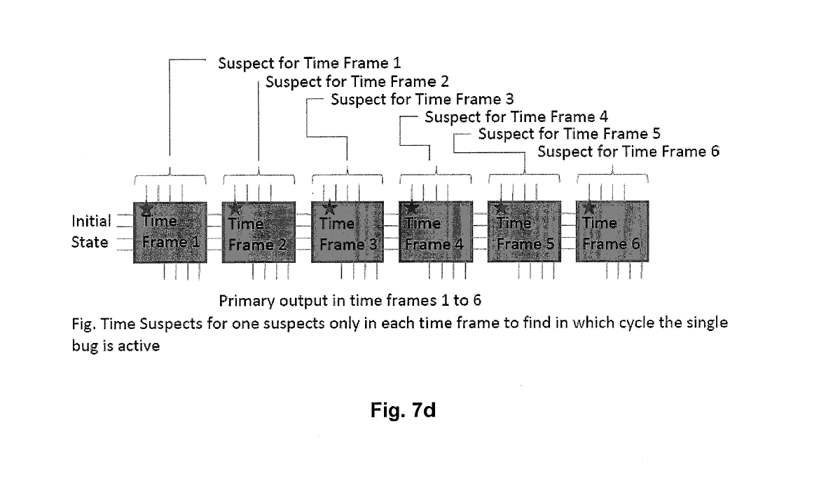

FIGS. 7a, 7b, 7c, 7d, and 7e illustrate the application of a time frame expansion based diagnosis method to identify under-constrained problems.

FIG. 7a shows conceptually how a sequential problem is modeled in the Boolean domain. Techniques using circuit and gate level analysis (such as simulation and path tracing) including BDDs, SAT, QBF, and other CNF problems may all use “Time Frame Expansion” models, which may also be referred to as an “Iterative Logic Array”. Such models enable the generation of combinational components in the “squares” known as time-frames, where the between the time frames are the transitions from one clock cycle to another. Note that it is also possible to represent the sequential problem by iteratively reasoning about one time frame at a time. But the Time Frame Expansion model has shown to be more practical. Other components are usually added to the Time Frame Expansion model to solve a particular problem such as property checking, circuit diagnosis, or path tracing (including as described by Veneris et al.).

FIG. 7b illustrates the use of the time frame expansion model where suspects (shown as stars in this Fig.) are placed on the input. In this case, the formulation is asking whether a single input can be the cause of the problem. If the answer to the question, is “yes”, then the solution (the individual input) is where bad stimulus is being fed or where bad constraints have been applied (or incomplete constraints). Note that since an input should be modeled for all time frames, all the suspects in the different time frames may be tied together (using a single CNF/circuit variable to represent all of the input signals, which has the same effect as tying them together). When this representation is enriched with the stimulus values from a trace and the expected/correct output, then it can be translated to CNF where the SAT question can be asked “Does there exist an input signal such that the circuit can result in the correct output value?”. The answer to this question can be answered by BDDs, SAT, QBF and other reasoning engines (also path tracing), to say which input suspects are “at fault”. A cardinality constraint (not shown) will determine how many suspects in combination can be used to answer the question.

FIG. 7c shows the application of the Time Frame Expansion model where “Time Suspects” are sought. In this case all of the suspects in the circuit (including input/stimulus suspects) are grouped by their time frame numbers (which corresponds to a clock cycle or stimulus event) in order to model a fix (any fix) in that time frame. Note, that all suspect lines in one given time frame will be tied together (or will use the same variables). Similar to the other problems, the Time Frame Expansion model is enhanced with stimulus, expected/correct values and cardinality constraints. The SAT question asked is “Does there exist any group of suspects representing a time frame such that any one of them can fix the problem?”. The answer is a time frame where at least one fix is required to fix the problem/failure.

FIG. 7d builds on FIG. 7c and illustrates the same question being asked for a single suspect in a time frame. This approach is most effective when used iteratively with other diagnosis techniques. For example, a circuit or stimulus diagnosis approach can find which circuit or input suspects are a solution, and then the shown model can be used to find out in what exact time frames the particular suspect is “active” (has been excited and it's effects propagated to the output). Another way to look at this is at what time (clock cycle) the suspect gates/functions/etc. must be fixed. In this case, the satisfiable solution can result in a waveform of values for which the suspect can “behave correctly” and thus results in a fixed waveform.

FIG. 7e, similar to FIG. 7d, shows a more detailed question asked about a single circuit/gate suspect and the exact time frame it is behaving incorrectly. In this case, the question asked is “Does the circuit behave correctly if the suspect gate A in time Frame N is replaced.” The answer to this question clearly shows what circuit element and at what time the problem occurs.

Note that for all of the SAT problems, it is possible to get from the SAT solver the values of the satisfied problem. In other words, every suspect that is returned can also contain a value for which the problem can be fixed. For example, in FIG. 5e, the solution of the SAT solver can return the exact values indeed for gate A in time frame N to fix the problem. Similarly in FIG. 5d, combining the suspect values in all time frames results in a “waveform” where there exists a value for every clock cycle.

### Correction Using Waveforms

The present invention also provides a system, method and computer program for enabling the correction of a hardware design. This aspect of the invention may be used in conjunction with the stimulus based hardware debugging solution described above

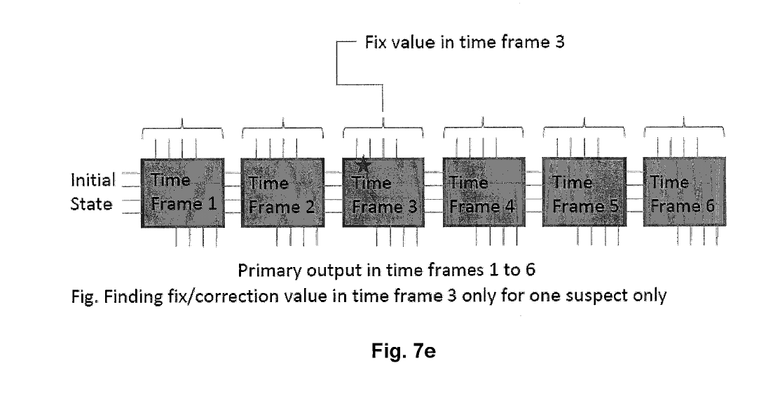

FIG. 8 illustrates a system in accordance with the present invention as implemented in a verification process. This aspect of the invention may be implemented as a final stage of hardware design debugging that includes: (1) verification; (2) debugging; and (3) correction. The hardware design may be provided in Hardware Description Language (HDL). The present invention provides correction hints which the user (such as an engineer) or an automated tool can use to assist in the correction step.

As explained above, generally speaking, the overall process of finding the source of errors in a design at the HDL level is referred to as “debugging” and the process of locating the error sources at the gatelevel and logic level is referred to as “diagnosis”. “Correction” typically refers to modification of a design at the gatelevel and logic level so as to eliminate or reduce error sources.

The correction approach of the present invention is different from the prior art manual processes in general use because limited user interaction is required for translating debugging feedback to the correction stage, which makes the present invention substantially automated. This invention, in one aspect thereof, is a hardware correction engine that facilitates correction of a design.

This aspect of the system of the present invention may be implemented as a hardware correction engine that is operable to generate one or more correction waveforms enabling the correction of a hardware design. Given one or more input signals, the hardware correction engine can generate one or more correction waveforms that, when applied to the hardware design, effect a change in the hardware design that remove symptoms of errors or bugs in the design.

The hardware correction engine may include or be linked to means for accepting user input and providing textual and/or graphical output to a user. The hardware correction engine may be operable to indicate one or more corrections, or areas of the hardware design for correction, that if implemented may result in the hardware design functioning as intended. The corrections may be implemented manually or automatically to correct the hardware design. The correction waveform may also indicate the relevant time at which a potential correction will work. It should be noted that the correction waveform can be provided as a textual and/or graphical waveform. For example, the correction waveform may be a sequence of values.

By means of the correction waveform and the hardware correction engine, a user could identify one or more suspect error sources. The user may correct the design and rerun a verification process, resulting in further suspect error sources or a correctly functioning hardware design.

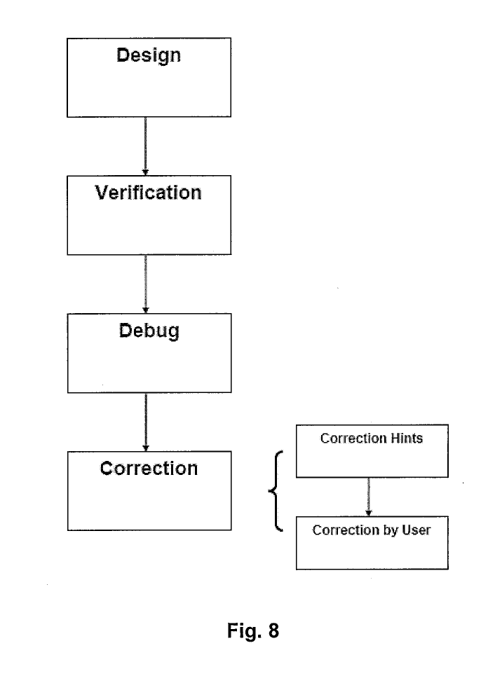

FIG. 9 illustrates an example of a correction waveform for correcting or fixing an error source of a hardware design. The gate, module, RTL line or other hardware component can be represented by “f”, which may be found to be the error location, either manually or automatically using an automated tool. “f” may have a simulated value which corresponds to the output of “f” when it is stimulated with a diagnose vector (also referred to as a verification vector, counter-example or test vector). The hardware correction engine can generate a sequence of values (which can be represented by a correction waveform) that can fix the circuit if “f” is replaced with any circuitry that produces the sequence of values.

The hardware correction engine may be provided with one or more inputs from the debugging stage and/or from a user to derive the correction waveform. The inputs may include a design input, one or more diagnose vectors comprising an input sequence and an output sequence, and optionally locations in the design to provide correction waveforms (such as which design signals, registers, wires, and gates to apply the correction). The design input may include for example any of a gate level netlist, register transfer level (RTL) description, or higher level representation. The diagnose vectors may include a set of initial state values.

The inputs may be provided by a user or an automated debugging tool, such as those by Veneris et al. (as previously mentioned), Vennsa™ or any SAT-based, BDD-based, simulation/path-trace based, etc. tools. The user may wish to provide the inputs, for example if the user suspects the location of the root cause of the bug or the user has a preferred location for a fix. The user may also specify certain signals to include in the correction waveform.

The correction waveforms may be applied to the hardware design to identify potential error sources in the hardware design. The input signals may be applied to the hardware correction engine to generate the one or more correction waveforms. If the signals are not chosen carefully, it may be the case that no sequence of values can correct or fix the error. In this case, no correction waveforms may be generated. If signal tuples (pairs, triples, etc.) are applied, correction waveforms tuples may be generated and applied to the design simultaneously.

For each set of input signals provided (including tuples) and for each diagnose vector, a correction waveform is generated spanning the length (time) of each diagnose vector.

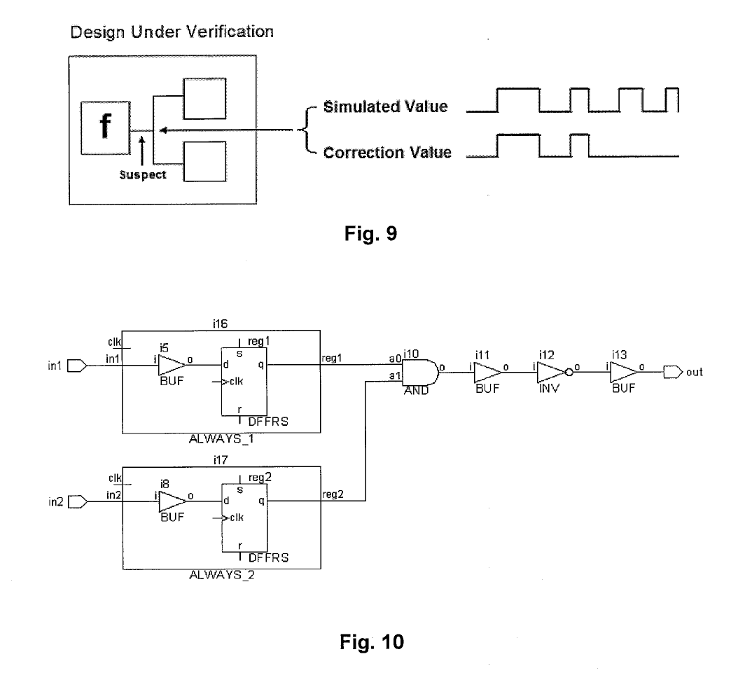

For example, consider the following design described in Verilog and shown in FIG. 10.

```
-------------------------------------
module ma(clk, in1, in2, out);
input clk, in1, in2;
output out;
wire out;
wire inter;
reg reg1, reg2;
always@(posedge clk)
  reg1 <= in1;
always@(posedge clk)
  reg2 <= in2;
assign inter = reg1 & reg2;
assign out = ~inter;
endmodule
--------------------------------------
```

Consider the following diagnose vector (note: out is the expected/correct value). The simulated value for “out” is shown in comments “//”. Where a value is not defined for a time, it keeps the previous value.

-------------------------------------
clk@0ns = 0
clk@10ns = 1
clk@15ns = 0
clk@20ns = 1
clk@25ns = 0
clk@30ns = 1
clk@35ns = 0
clk@40ns = 1
in1@ns = 0
in1@25ns = 1
in2@0 = 0
in2@15ns = 1
out@0 = X (undefined)
out@10ns = 1
out@20ns = 0 //simulated: 1
out@30ns = 0 //simulated: 0
out@40ns = 0 //simulated: 0
-------------------------------------

If the user requests from the hardware correction engine the correct waveform for in1, reg1 and inter, the following can be provided. Note that many other sequences may also exist. The sequences below can be converted and shown in a waveform viewer or provided textually as given below.

----------------------------------------
in1@0 = 0
in1@15ns = 1
-----------------------------------------
---------------------------------------
reg1@20 = 1
-----------------------------------------
---------------------------------------
inter@10 = 0
inter@20 = 1
-----------------------------------------

Given the correction waveform, a user or an automated tool can determine one or more functions to implement the correction waveform at the gatelevel or logic level or RTL. By addressing the error source, the user or automated tool can remove the error or bug.

The correction waveform can be generated in various ways including, for example, simulation-based techniques, BDD-based techniques, SAT-based techniques and replacement or logic correction. Certain techniques may work better for certain problems than for others.

In a simulation-based technique, values are applied (either randomly or using a heuristic or algorithm) to each signal and each sequence to simulate them. If the simulation removes the observed error (failure), then it is a viable correct sequence.

In a BDD-based technique, a BDD graph is built for each signal and each vector where the only decision nodes are the signals in question for each time-frame (clock cycle). The values satisfying the BDD problem are the correct waveform. This technique may be better for smaller designs. A BDD-based technique formulates the problem in canonical manner and finds a satisfying assignment by traversing the BDD graph.

In a SAT-based technique, the circuit is translated into CNF, the CNF is unrolled into multiple time-frame, and the signals where correction waveforms are required are left unconstrained for each time-frame. Logic or CNF is added to constrain that only certain number of unconstrain signals can be assigned a value by the SAT solver at a time. This number is called the error cardinality. One specific way to model the correction points is to a multiplexer to the signals of interest and only allow certain number of the select lines to be selected. A counter, sorter or other cardinality constrain will limit the number of correction waveforms (tuples) that are allowed. Finally, the SAT problem is generated and can be solved by a SAT solver. Note that a SAT problem can be generated for each location or combined to solve all location problems in one run. Which approach to chose is based on performance. Note that similar construction can be derived for QBF solvers, Max-SAT solvers, on UNSAT solvers. The solution found is a sequence of values that when applied to the design will prevent the failure from occurring and this can be view as a correct waveform. Another option is to constrain the SAT problem to refrain from generating non-deterministic value sequences. This means that no found solutions for any two time-frames will be different if their inputs are the same. Similarly this concept can be extended to determinism across multiple vectors. This may be the preferred technique. These solvers use branching and resolution techniques to find a satisfiable assignment to the problem variables.

The correction waveforms (can be generated in sets) can be forwarded to correction or replacement techniques or to an engineer who will be manually making the correction. In an automated replacement or logic correction algorithm, gate level or RTL level logic will be generated from the existing signals of the circuit (through synthesis) to result in the logic function that adheres to the correction waveform. Each signal is replaced with a candidate correct logic circuit and the input of the logic circuit is connected appropriately. If the verification (simulation of formal verification) of the logic cone removes the failure, then the new logic is indeed a suitable correction/replacement. The proposed invention can also be an input into these correction algorithms to reduce their search space and increase their efficiency.

The benefit of the correct waveform to the user is greatest when it is presented with the concept of fix/correction times. In other words, times specific to a vector can be found when the fix values are truly necessary. These can be viewed as times when the bug is active (the bug is excited and observed) or times when the correction waveforms take affect and influence the output of the design or circuit.

One technique for finding correction times is to build a SAT problem composed of the design, the stimulus vector and expected correction point. The locations where the corrections are necessary can be provided optionally (these could be the same point where correction waveforms are found). If not provided, all such points can be found, or a subset can be found using heuristics or a hierarchical manner based on the circuit instantiation hierarchy or the gatelevel circuit dominance relationship. For all locations of interest, a multiplexer for each time-frame is introduced representing the fix at that time. The entire problem can be converted to SAT, QBF, max-sat, etc. and the solver is asked to answering the question whether 1 time-frame alone with a correct value can solve the problem (and which). If required or requested by the user, the same question is posed for 2 locations, 3 locations, and so on. Since the SAT solver solution includes values for the different variables, the solution corresponding to one time frame is whether the multiplexer select line is set to 1 in that time-frame.

Other algorithms for finding the correction times can be made by finding time frame groups when fixes are necessary. This can be done conceptually by grouping a window of time-frame together and asking the questions on this window. The window can be iteratively moved across the trace. The window can also be iteratively (hierarchically) reduced in size until the minimal size window is found.

Another way to derive the correction times described above is by using a heuristic based on the difference with respected to the simulated values/ Thus, the correction waveform sequence can be modified to only show times when the correct value is different from the simulated value, which corresponds to parts of the sequence that are relevant to solving the problem. This makes it clear to the user when (at which times and clock cycles) the user must change the functionality of the hardware design to remove the error.

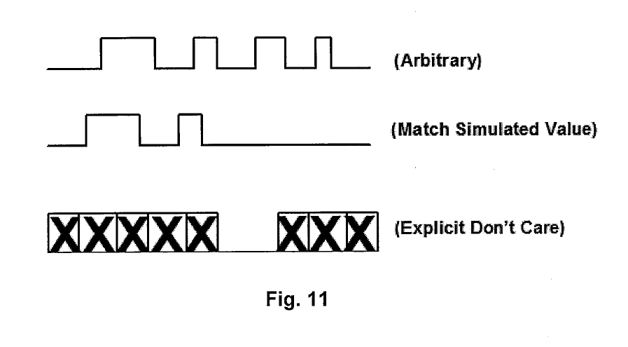

Another improvement is to show only the values that are not Observable Don't Cares (ODC). ODCs are defined as signal values that do not affect the outcome of the circuit or a logic cone. In this case, a signal can have a “correct value” for every time or clock cycle; however not all these values influence the outcome of the failure. FIG. 11 illustrates an example of a correction waveform including explicit “don't cares”. The “don't cares” correspond to sub-sets of the sequence that are unnecessary for the correction. To find ODC, a circuit (gatelevel or RTL) based path tracing algorithm is necessary to traverse the circuit and determine which signals are ODCs. Estimation or incomplete ODC algorithms exist that will not require a complete path-tracing algorithm and can do it on a subset of the problem, circuit or trace.

### REFERENCES

[1] M. Abramovici, P. R. Menon, D. T. Miller, “Critical path tracing—an alternative to fault simulation,” in Proc. of Design Automation Conference, 1988, pp. 468-474
[2] S. Huang, “Speeding up the Byzantine fault simulation using symbolic simulation,” in Proc. of VLSI Test Symposium, 2002, pp. 193-198
[3] A. Smith, A. Veneris, M. F. Ali, and A. Viglas, “Fault diagnosis and logic debugging using Boolean satisfiability,” IEEE Trans. on CAD, vol. 24, no. 10, pp. 1606-1621, 2005

1. A computer implemented method for debugging pre-fabricated digital synchronous hardware comprising the steps of:
(a) using one or more debugging techniques or technologies to identify one or more potential error sources in a gate level representation of a hardware design; and
(b) analyzing the potential error sources using one or more suitable diagnosis techniques, by changing the stimulus or constraints in connection with at least one verification problem, so as to provide automated determination of potential errors sources in the design related to the stimuli or constraints for the hardware design.

2. The method of claim 1, further comprising the steps of:
(a) determining the signals of the hardware design where constraints or stimuli are generally added (or “target signals”); and
(b) applying the diagnosis techniques to the target signals so as to identify any under-constrained signals corresponding to under-constrained problems, by adding a model-free error suspect or error candidate in connection with the application of the one or more diagnosis techniques.

3. The method of claim 1, comprising the further steps of:
(a) generating one or more correction waveforms for each of the under-constrained signals to provide to a human user or computer, analysis data for debugging the hardware.

4. The method of claim 2, wherein the one or more correction waveforms are used to generate one or more value sequences for correcting one or more errors in the hardware.

5. The method of claim 4, wherein the under-constrained signals are combined with one or more correction waveforms to provide a stimulus fix through a test bench, software fix through processor instructions, or external fix through change of output-input communication of a fabricated chip, by providing a value sequence that is operable to avoid an error in the hardware.

6. The method of claim 1 wherein the diagnosis techniques includes one or more of:
(a) formulation of a Boolean Satisfiability (SAT) based problem;
(b) application of a Binary Decision Diagram (BDD);
(c) application of a fault simulation or critical-path tracing method; or
(d) formulation of a Quantified Boolean Formula (QBF) based problem.

7. The method of claim 7, comprising the further steps of:
(a) determining the signals of the hardware design where constraints or stimuli are generally added (or “target signals”); and
(b) analyzing the target signals based on one or more of:
(i) an individual basis, or a grouping of target signals;
(ii) a single pass or in multiple passes;
(iii) a hierarchical, iterative, or flat application of the diagnosis techniques.

8. The method of claim 7, comprising the further step of using a Time Frame Expansion model in connection with the one or more diagnosis techniques.

9. The method of claim 8, wherein the Time Frame Expansion Model is enhanced with stimulus, expected/correct values, and/or cardinality constraints.

10. The method of claim 9, wherein the method is operable to produce at least one time frame where at least one fix is required to fix a problem or failure.

11. The method of claim 9, wherein the method is operable to identify errors even though the target signals with the same values are required for different frames.

12. A system for automated debugging for pre-fabricated digital synchronous hardware comprising:
(a) a computer;
(b) a computer application linked to the computer, the computer application being operable to provide instructions to the computer that enable the computer to:
(i) apply one or more debugging techniques or technologies to identify one or more potential error sources in a gate level representation of a hardware design; and
(ii) analyze the potential error sources using one or more suitable diagnosis techniques, by changing the stimulus or constraints in connection with at least one verification problem, so as to provide automated determination of potential errors sources in the design related to the stimuli or constraints for the hardware design.

13. The system of claim 12, wherein the computer application is operable to:
(a) determine the signals of the hardware design where constraints or stimuli are generally added (or “target signals”); and
(b) apply the diagnosis techniques to the target signals so as to identify any under-constrained signals corresponding to under-constrained problems, by adding a model-free error suspect or error candidate in connection with the application of the one or more diagnosis techniques.

14. The system of claim 12, wherein the computer application is further operable to:
(a) generate one or more correction waveforms for each of the under-constrained signals to generate analysis data for debugging the hardware.

15. The system of claim 14, wherein the one or more correction waveforms are used to generate one or more value sequences for correcting one or more errors in the hardware.

16. The system of claim 14, wherein the under-constrained signals are combined with one or more correction waveforms to provide a stimulus fix through a test bench, software fix through processor instructions, or external fix through change of output-input communication of a fabricated chip, by providing a value sequence that is operable to avoid an error in the hardware.

17. The system of claim 12, wherein the computer application is operable to apply one or more of the following diagnosis techniques:
(a) formulation of a Boolean Satisfiability (SAT) based problem;
(b) application of a Binary Decision Diagram (BDD);
(c) application of a fault simulation or critical-path tracing method; or
(d) formulation of a Quantified Boolean Formula (QBF) based problem.

18. The system of claim 12, wherein the computer application is operable to:
(a) determine the signals of the hardware design where constraints or stimuli are generally added (or “target signals”); and
(b) analyze the target signals based on one or more of:
(i) an individual basis, or a grouping of target signals;
(ii) a single pass or in multiple passes;
(iii) a hierarchical, iterative, or flat application of the diagnosis techniques.

19. The system of claim 18, the computer application being further operable to apply a Time Frame Expansion model in connection with the one or more diagnosis techniques.

20. The system of claim 19, wherein the Time Frame Expansion Model is enhanced with stimulus, expected/correct values, and/or cardinality constraints.

21. The system of claim 20, wherein the system is operable to produce at least one time frame where at least one fix is required to fix a problem or failure.

22. The system of claim 21, wherein the method is operable to identify errors even though the target signals with the same values are required for different frames.

23. A computer program product for debugging pre-fabricated digital synchronous hardware, the computer program product for use on a computer, the computer program product comprising:
(a) a computer usable medium; and
(b) computer readable program code recorded or storable in the computer usable medium, the computer readable program code defining a debugging application on the computer that is operable on the server computer to:
(i) using one or more debugging techniques or technologies to identify one or more potential error sources in a gate level representation of a hardware design; and
(ii) analyze the potential error sources using one or more suitable diagnosis techniques, by changing the stimulus or constraints in connection with at least one verification problem, so as to provide automated determination of potential errors sources in the design related to the stimuli or constraints for the hardware design.
